(19) United States
(12) Patent Application Publication
(10) Pub. No.: US 2009/0164715 A1
(43) Pub. Date: Jun. 25, 2009

(54) Protecting Against Stale Page Overlays

(75) Inventors: Tara L. Astigarraga, Vail, AZ (US); Michael E. Browne, Staatsburg, NY (US); Joseph Demczar, Salt Point, NY (US); Eric C. Wieder, New Paltz, NY (US)

Correspondence Address: INTERNATIONAL BUSINESS MACHINES CORPORATION;Richard Lau, IPLAW DEPARTMENT / Bldg 008-2, 2455 SOUTH ROAD - MS P386, POUGHKEEPSIE, NY, 12601, US

(73) Assignee: INTERNATIONAL BUSINESS MACHINES CORPORATION, Armonk, NY (US)

(21) Appl. No.: 11/961,000

(22) Filed: Dec. 20, 2007

(51) Int. Cl. G06F 12/00

(52) U.S. Cl. 711/112; 711/E12.069

(57) ABSTRACT

A method, data processing system and program product for protecting against stale page overlays which includes executing a process in memory of the data processing system. A storage controller pages data from the memory to a disk in pages when the memory is constrained by other processes being executed by the data processing system. Data is then paged from the disk into memory in a one or more paged-in pages. The paged-in page is updated with updated data by the process, and the version on the disk is marked as stale. The storage controller commands the disk to make the stale disk version of the updated paged-in page as write-only, thereby providing that the disk version may be overwritten with new data while providing that the disk version cannot be read.

### FIELD OF THE INVENTION

This invention relates to recovering data from a data storage medium, and particularly to protecting against recovering stale pages from a disk.

### BACKGROUND OF THE INVENTION

Currently stale page technology is limited by the fact that when pages are modified and outdated, they are marked as stale by the virtual memory manager, but the classification is not changed from read-write to write-only on disk. This leaves the computer vulnerable to silently using stale pages when a coding defect in virtual memory management is encountered. This could cause a problem during recovery of a system if stale pages are in the mix of data trying to be recovered from disk.

The technology to mark the pages as stale exists, but currently lacks the implementation to fully optimize the use of this technology and to further protect from data being falsely recovered.

In the prior art traditional process flow, when a process A is being executed, and the memory becomes constrained by demands from other processes, the Operating System, using a memory manager such as Virtual Memory Manager (VMM) available from International Business Machines Corp. (IBM), pages out memory using a Least Recently Used algorithm (LRU) from process A where it is written to a disk. Process A then becomes active and VMM pages in the previously paged out page(s). Process A then updates one or more pages, thus making the version stored on disk ‘stale’. The stale page(s) remains on disk marked as stale, but still with read-write permissions until the invalid/stale disk address is over-written with new data. Thus, the prior art allows for these stale pages to remain on disk with read-write access.

U.S. Pat. No. 6,684,305 B1 issued Jan. 27, 2004 to Deneau for MULTIPROCESSOR SYSTEM IMPLEMENTING VIRTUAL MEMORY USING A SHARED MEMORY COHERENCE discloses a multiprocessor system implementing virtual memory using a shared memory and a page replacement method for maintaining paged memory coherence including a first and second processor, wherein the virtual memory page replacement method is designed to help maintain paged memory coherence with the multiprocessor computer system. In one embodiment, the method includes accessing each page table entry of a set of page table entries of the second processor. Each page table entry of the set of page table entries corresponds to a different memory page of a set of pages of the second processor. Each page of the set of pages of the second processor is stored in a memory and corresponds to a first page of the first processor to be removed from the memory. Each page table entry of the second processor includes a dirty (D) bit indicating whether or not the corresponding page of the second processor needs to be written to storage.

US Patent Application Publication NO. 2002/0073298 A1 published Jun. 13, 2002 by Geiger et al. for SYSTEM AND METHOD FOR MANAGING COMPRESSION AND DECOMPRESSION OF SYSTEM MEMORY IN A COMPUTER SYSTEM discloses allowing a processor or I/O master to address more system memory than physically exists. The page fault boundary is dynamically controlled by the virtual memory manager software to optimize the balance between active and inactive pages in the system memory and “stale” pages stored on disk. The memory subsystem is coupled to the I/O or disk subsystem by the I/O peripheral bus interfaces, e.g., the PCI bus. The I/O disk subsystem comprises the disk controller, the optional disk cache memory, and the actual physical hard disk or disk array which is used to store nonvolatile/non-active pages. In general, multiple subsections of the CPU, memory, and disk subsystems may be used for larger capacity and or faster operation.

US Patent Application Publication No. 2003/0061457 A1 published Mar. 27, 2003 by Geiger et al. for MANAGING A CODEC ENGINE FOR MEMORY COMPRESSION/DECOMPRESSION OPERATIONS USING A DATA MOVEMENT ENGINE discloses managing a functional unit in a system using a data movement engine with compressed cache allocation using a set of novel cache algorithms to optimize compressed storage for the most active of the stale pages normally swapped to disk. In other words, based on the algorithm of one embodiment, pages that show a history of reuse may be compressed and stored in the compressed cache, while pages that show little history of reuse may be compressed and swapped to the compressed page partition in the disk subsystem. Thus, as the compressed cache memory becomes full, the dynamic algorithm of the compressed cache manager tags compressed pages according to a least recently used, lazy replacement LRU/LZU algorithm and retires low utilization compressed pages into the disk subsystem. In an alternate embodiment, the compressed pages that are stored onto the disk subsystem may not be stored in a compressed partition but still may be compressed for faster file transfer and bus I/O bandwidth improvements.

US Patent Application Publication No. 2006/0212657 A1 published Sep. 21, 2006 by Tuel for METHOD AND SYSTEM FOR PAGE-OUT AND PAGE-IN OF STALE OBJECTS IN MEMORY discloses moving an object from a short lived memory area in a program address space on a physical memory into a tenured memory area in response to a determination that the object has not been freed from the short lived memory area. If the object in the tenured memory area is determined to be stale, then the object is moved to a native memory area in the program address space. If the object in the native memory area is referenced by a processing unit, then the object will be moved back to the tenured memory area. If the object is not referenced in the native memory area, then the operating system will determine if page-out of the object to a page file on the hard disk is necessary. If page-out is necessary, then the object is moved to the page file. If the object in the page file is referenced, then the object is moved into the program address space.

US Patent Application Publication No. 2006/0277389 A1 published Dec. 7, 2006 by Hepkin et al. for PAGE REPLACEMENT POLICY FOR SYSTEMS HAVING MULTIPLE PAGE SIZES discloses utilizing multiple page sizes for virtual memory paging. Following the selection of a replacement page size pool, the page replacement procedure continues with the selection of one or more pages to be replaced from the selected page size pool. Many know victim page selection techniques, such as LRU, are known and may be utilized. As part of the replacement page selection, the page frame number of the page frame that will be utilized for the incoming page is obtained. If the page selected has been modified, possibly as indicated in the corresponding page table entry within a page table, the memory version of the page must be copied out to secondary storage. Following selection of the replacement page(s) and possible page-out, the page fault process continues with the requested page(s) being copied from secondary storage into the selected replacement page frame(s) in main memory. If the selected page frame(s) is different than the requested page size, the frames are first converted to the requested page size and thus shifted to the memory pool of the requested page size. Next, tables are updated to reflect the revised contents of main memory, the requested data is returned to the requesting processor and the process concludes at which point the faulting process may retry the memory access request.

US Patent Application Publication No. 2007/0006000 A1 published Jan. 4, 2007 by Jain et al. for USING FINE GRAINED POWER MANAGEMENT OF PHYSICAL SYSTEM MEMORY TO IMPROVE SYSTEM SLEEP discloses allowing portions of the system volatile memory to be independently power managed. The physical system memory improves system sleep using a shadowing component that progressively shadows the pages in the system memory as these pages become stale. A page becomes stale when it is not currently in use or has not been used for a predetermined period of time. Stale pages may include memory pages from a paged or not-paged memory pool. Similar to the shadowing operation, the stale pages may be shadowed when doing so is convenient and power-efficient. In one embodiment, stale pages include read-only pages and may be shadowed at the same opportune times.

Challenger et al., A Scalable and Highly Available System for Serving Dynamic Data at Frequently Accessed Web Sites, Supercomputing, 1998, SC98 IEEE/ACM Conference, Pages 47-72 (7-13 Nov. 1998) discloses a system and key techniques used for achieving performance and high availability at the official Web site for the 1998 Olympic Winter Games. A key feature of the Web site was that the data being presented to clients was constantly changing. One technique was to cache dynamic pages so that they only had to be generated once. An algorithm identifies the cached pages that have become stale as a result of changes to underlying data on which the cached pages depend, such as databases. Stale pages were updated directly in the cache which obviated the need to invalidate them.

Malkawi et al. Page Replacement In Distributed Virtual Memory Systems, Parallel and Distributed Processing, 1992, Proceeding of the Fourth IEEE Symposium, pages 394-401 (1-4 Dec. 1992) discloses page replacement and page out policies in distributed virtual memory. Three replacement algorithms are disclosed. The algorithms are adapted versions of the least recently used policy.

Hunt et al. Multiprocessor Memory management: Integrating Four-Address Virtual Memory and Aliased Page Tables, Computers and Communications, 1996, Conference Proceedings of the 1996 IEEE Fifteenth Annual International Phoenix Conference, Pages 263-267 (27-29 Mar. 1996) discloses a four-address virtual memory for providing sufficient degrees of freedom in the address translation process to support nearly and desired sharing scheme. Aliased page tables provide an efficient mechanism for managing the copy-on-write sharing associated with some multiprocessor memory architectures.

Kermarrec et al. Integrating Page Replacement in a Distributed Shared Virtual Memory, Distributed Computing Systems, 1994, Proceedings of the 14^{th} International Conference, Pages 355-362 (21-24 Jun. 1994) discloses an algorithm to include page replacement mechanism for distributed shared virtual memory dedicated to diskless embedded systems. A memory partition optimizes memory space use.

### SUMMARY OF THE INVENTION

A primary object of the present invention is to introduce a method to protect against recovering stale pages from disk.

Another object of the present invention is to send commands to the disk when the page is marked stale by VMM. The commands sent to the disk will mark the stale disk address as write-only, removing the possibility of stale page overlays corrupting recovery data or being read. By marking them as write-only it will not be possible to read the invalid/stale disk address and the disk space could then only be re-written as needed.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is an illustration of a data processing system including the paging system of the present invention; and

FIG. 2 is a flowchart of the paging system of FIG. 1.

The detailed description explains the preferred embodiments of the invention, together with advantages and features, by way of example with reference to the drawings.

### DETAILED DESCRIPTION OF THE INVENTION

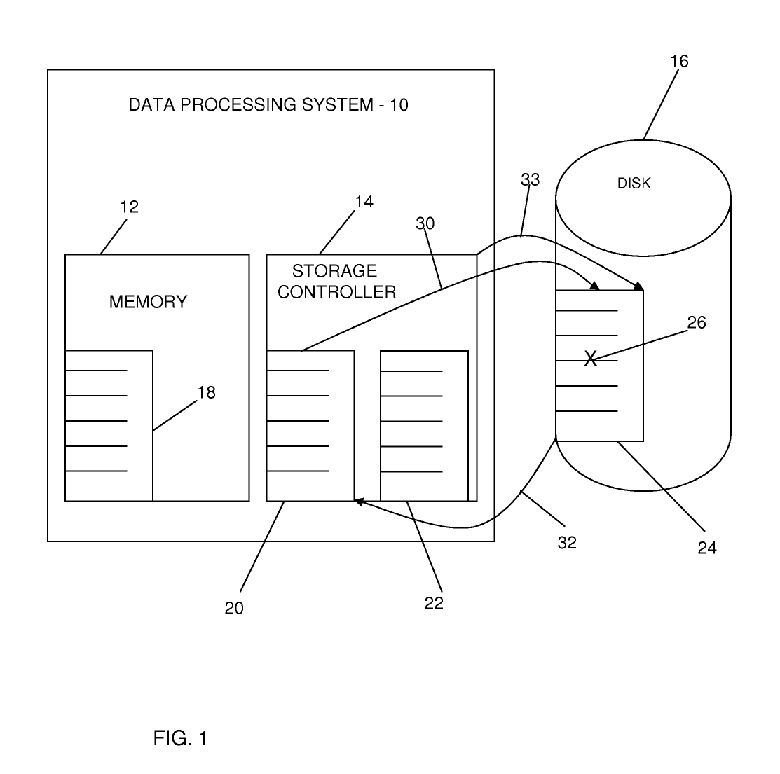

FIG. 1 is an illustration of a data processing system 10 having the paging system of the present invention and includes a memory 12 having a process A 18. It will be understood that the data processing system 10 may be only a single computer, or may be multiple computers arranged in a network, as is will understood. The data processing system 10 also includes a storage controller 14 including a Virtual Memory Manager (VMM). The storage controller 14 includes one or more pages 20 of process 18 which are paged in and out of the storage controller by VMM, as is well understood. When the memory 12 becomes constrained by other demands from the other processes, VMM pages out via a Least Recently Used (LRU) algorithm from process A 20, and at least one page goes to disk 16 shown at 30. When process A 20 becomes active VMM pages in the process A 4 k page, as shown a 32. When process A 18 updates the page 22 and marks the version 26 stored on the disk 18 as ‘stale’. At 33, a command is sent from the storage controller 14 to the disk 16 to mark as write-only the stale page 26. Thus, the stale page 26 remains on disk 16 marked as write-only stale, removing the chance for stale page overlays. The stale page 26 remains on the disk 16 marked as write-only stale until it is over-written with new data vial normal processes.

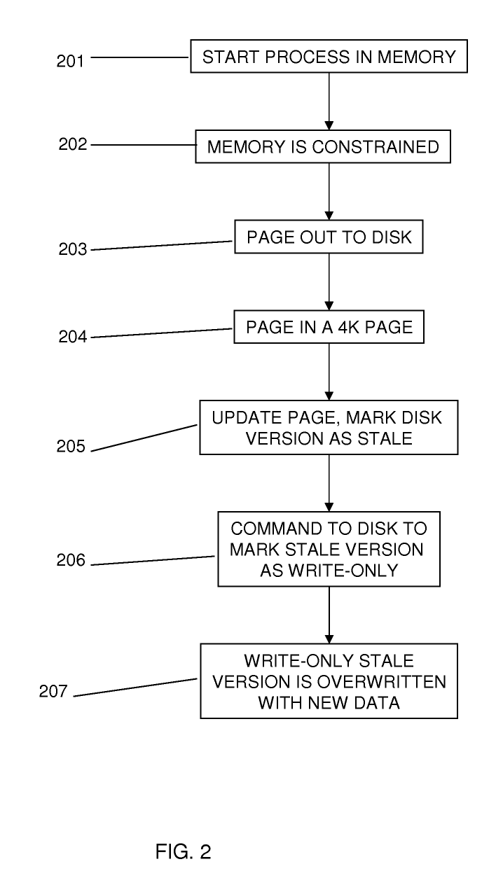

FIG. 2 is a flow chart of one embodiment of the present invention wherein at 201, a process is started in the memory. At 202, the memory is constrained because, for instance, of other demands from other processes. At 203, VMM pages out via and LRU algorithm one or more pages from the process to disk. At 204, the process again becomes active, and pages in pages from the disk. This paging in includes one or more 4 k pages. At 205, the pages from the disk are updated, and the version of the pages on the disk is marked as stale. At 206, a command is sent to the disk to mark the stale version as write-only. The stale page remains on the disk marked as write-only stale thereby removing the chance for stale pate overlays of the process. At 207, the write-only stale version is overwritten with new data during the course of data processing operations. Thus the embodiment of present invention provides a solution to the problem of leaving stale pages by marking them as read-write thereby avoiding the potential to cause data corruption during recovery.

The present invention provides that VMM send a write-only command to disk with the address of the stale page, thus marking the stale page on disk as write-only. The advantage of using this method as described above would be in removing the chance of accidentally reading stale page data during debug or recovery procedures. The process of marking the stale pages as write-only is a simple solution to further help protect users from data corruption. By actively marking these pages as write-only the chance for data integrity problems that can occur by reading in stale data is reduced.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagram depicted herein is just an example. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for protecting against page overlays comprising:
executing a process in memory of a data processing system;
paging with a storage controller, data from the memory to a disk in pages when the memory is constrained;
paging data from said disk into memory in a paged-in page;
updating the paged-in page with updated data by said process; and
commanding the disk with the storage controller to make the disk version of the updated paged-in page as write-only, thereby providing that the disk version may be overwritten with new data while providing that the disk version cannot be read.

2. The method of claim 1 further comprising marking the updated version of the paged-in page on the disk as stale.

3. The method of claim 1 wherein the memory is constrained by other processes being executed by the data processing system.

4. The method of claim 1 wherein the paging to the disk and paging in to the memory from said disk is in multiple pages.

5. The method of claim 4 wherein each version of a page on said disk is marked as stale when the version of each corresponded page in memory is updated.

6. The method of claim 4 wherein each stale page on the disk is marked as write-only.

7. The method of claim 4 wherein each version of a page on the disk is marked as write-only when the version of each corresponding page in said memory is updated.

8. A data processing system for protecting against page overlays comprising:
memory for storing data including processes being executed;
a disk for storing data in pages;
a storage controller controlling the transfer of a page of data from said memory to said disk when said memory is constrained, paging data from said disk into memory in a paged-in page, and commanding the disk to make the disk version of the paged-in page as write-only when the paged-in page is updated by said process, thereby providing that the disk version may be overwritten with new data while providing that the disk version cannot be read.

9. The data processing system of claim 8 further comprising marking the updated version of the paged-in page on said disk as stale.

10. The data processing system of claim 8 wherein said memory is constrained by other processes being executed by the data processing system.

11. The data processing system of claim 8 wherein the paging to said disk and paging in to said memory from said disk is in multiple pages.

12. The data processing system of claim 11 wherein each version of a page on said disk is marked as stale when the version of each corresponded page in memory is updated.

13. The data processing system of claim 12 wherein each stale page on said disk is marked as write-only.

14. The data processing system of claim 12 wherein each version of a stale page on said disk is marked as write-only when the version of each corresponding page in said memory is updated.

15. A program product for protecting against page overlays comprising:
a computer readable medium having recorded thereon computer readable program code for performing the method comprising:
executing a process in memory of a data processing system;
paging with a storage controller, data from the memory to a disk in pages when the memory is constrained;
paging data from said disk into memory in a paged-in page;
updating the paged-in page with updated data by said process; and
commanding the disk with the storage controller to make the disk version of the updated paged-in page as write-only, thereby providing that the disk version may be overwritten with new data while providing that the disk version cannot be read.

16. The program product of claim 15 wherein the method further comprises marking the updated version of the paged-in page on the disk as stale.

17. The program product of claim 15 wherein the memory is constrained by other processes being executed by the data processing system.

18. The program product of claim 15 wherein the paging to the disk and paging in to the memory from said disk is in multiple pages.

19. The program product of claim 18 wherein each version of a page on said disk is marked as stale when the version of each corresponded page in memory is updated.

20. The program product of claim 18 wherein each version of a page on the disk is marked as write-only when the version of each corresponding page in said memory is updated.
